(19) United States
(12) Patent Application Publication
(10) Pub. No.: US 2003/0142653 A1
(43) Pub. Date: Jul. 31, 2003

(54) Internal code control system and method for wireless data download

(76) Inventors: Ming-Ru Jiang, Tao Yuan Hsien (TW); Chen-Hsiang Yu, Tao Yuan Hsien (TW)

Correspondence Address: Wen Liu, LIU & LIU, 811 West 7th Street, Suite 1100, Los Angeles, CA, 90017, US

(21) Appl. No.: 10/295,378

(22) Filed: Nov. 15, 2002

Related U.S. Application Data
(60) Provisional application No. 60/352,093, filed on Jan. 25, 2002.

(51) Int. Cl. H04Q 7/24

(52) U.S. Cl. 370/338; 370/352

(57) ABSTRACT

A system and method for the transfer of media content from an Internet server to a portable device is disclosed which may be configured using currently existing WAP and Internet server technologies with a new file downloading mechanism called Internal Code Control which makes use of Multipurpose Internet Mail Extension types and file segmentation techniques to facilitate file transfer and download verification. An Index Parsing method of the Internal Code Control mechanism is disclosed for facilitating content download and billing functions.

This application makes a claim of priority from U.S. Provisional Application No. 60/352,093 (attorney docket no. 1062/204), entitled “Internal Code Control Download Mechanism”, filed Jan. 25, 2002 in the names of Yu et al, which is incorporated by reference as if fully set forth herein.

### BACKGROUND OF THE INVENTION

1. Field of the Invention

This invention relates generally to a content delivery system and method for the transfer of digital files, and more specifically to the download of digital media files residing on an Internet server to a portable device via a browser. An index parsing method is disclosed for defining content format and segmenting content for download from an Internet server.

2. Description of Related Art

Portable communication devices that are able to browse the Internet and download content have become widely used, such as Wireless Application Protocol (WAP) enabled mobile phones and Personal Digital Assistants (PDA's). WAP has become an increasingly popular means for providing services to portable devices. It allows the portable device to act as a simple web browser, but optimizes the markup language, scripting language, and the transmission protocols for wireless use. The optimized protocols are translated to plain Hypertext Transfer Protocol (HTTP) by a WAP Gateway. One feature of such devices which has gained popularity among consumers, and has the potential to be a significant profit center for carriers (or service providers), is the downloading of multimedia elements such as graphics, ringtones, games, etc. to the mobile phone. Current systems and methods for transferring multimedia elements to mobile phones involve the use of proprietary server side hardware and software technology and download protocols which are not cost effective for carriers who wish to offer such features to mobile phone users at an attractive price. Therefore, it would be desirable to create a new low cost and easy to implement multimedia downloading system and method for mobile phones which provides for simple downloading using existing server technology in conjunction with a new index parsing method.

### SUMMARY OF THE INVENTION

The content delivery system and method of the current invention may be configured using currently existing WAP and Internet server technologies with a new file downloading mechanism called Internal Code Control (ICC) which makes use of Multipurpose Internet Mail Extension (MIME) types and file segmentation techniques to facilitate file transfer and download verification. According to the current invention, downloading functions of the ICC mechanism may be accomplished via an Index Parsing (INP) method.

It is one object of the present invention to provide portable/handheld devices (e.g., PDA's, mobile phones, etc.) with multimedia download functions via a WAP browser.

It is another object of the present invention to provide an ICC download mechanism which can be used to download relatively large multimedia files.

It is a further object of the present invention to reduce the cost for operators to have to purchase additional hardware to support download services to portable devices.

It is yet another object of the present invention to provide optional payment functions for the current ICC media content download mechanism such that operators may bill users for downloaded media content.

In general, the INP method of the current invention presents new MIME types to be implemented on both server and portable devices which, along with a download protocol, facilitate the transfer of media files from a server to a portable device via ordinary browser based communications. A second embodiment of the ICC mechanism of the current invention involves a file naming protocol and specification to defining content format and enable organization and download of media files.

In one aspect of the present invention, a content download system is provided for transferring media content from an Internet server to a portable device.

In another aspect of the present invention, an ICC mechanism is provided to facilitate downloading functions of the content download system.

In one embodiment of the current invention, the content download system comprises a portable device, an Internet server, a wireless gateway, a download index MIME type file and an acknowledgement MIME type file, a wireless communication means, and an optional billing means.

In another embodiment of the current invention, the ICC mechanism comprises an INP method for the download (and optional purchase) of media content on a portable device using existing WAP browser, Internet server, and wireless gateway technology. The system is also expandable to download other file types and to work with different download protocols and specifications. Two new MIME types are provided for facilitating content download to portable devices. A Download Index (.din) file is provided as the means for data delivery between a web server and portable device through a gateway. An acknowledgement (.ack) file is provided as the means for verifying and confirming download of the media file and loading the content into Flash memory of the device. Because standard WAP Web clients use MIME types to interpret data retrieved from Internet servers, no additional browser or server side technology is necessary to facilitate downloads once the MIME types are properly included on both the portable device and the Internet server. In another aspect of the current embodiment, a download protocol is disclosed using both the Download Index and Acknowledgement files to facilitate downloading and verification functions for media content.

In yet another embodiment of the current invention, the ICC mechanism comprises a method for naming file segments and delineating file types on the web server for easy download by the portable device. Media files are segmented according to the predefined specification and named such that the file type and number of segments for a particular download will be discernable by the browser.

In still a further embodiment of the current invention, a billing function is provided to facilitate payment for downloaded media content to the portable device.

This invention has been described herein in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a chart showing the tag definitions of a download index file according to the present invention.

FIG. 2 is a sample download index file.

FIG. 3 is a chart showing the tag definitions of the acknowledgement file according to the present invention.

FIG. 4 is a sample acknowledgement file.

FIG. 5 is a schematic representation of the ICC system according to the present invention.

FIG. 6 is a process flow diagram of the INP method of the current invention.

FIG. 7 is a schematic diagram showing the INP process steps for downloading a media content file using the present invention.

FIG. 8 is a chart showing another embodiment of the ICC method according to the current invention.

FIG. 9 is a process flow diagram showing the process steps of another embodiment for downloading a media content file using the present invention.

FIG. 10 is a sample dynamically generated download index file names.

FIG. 11 is a process flow diagram showing server side object segmentation techniques.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. It is understood that the Internal Code Control concept of the present invention may be applied for portable devices of any kind including laptop computers, cellular/mobile phones, personal digital assistants, etc. It is also understood that while the present invention is best explained in reference to portable devices implementing WAP, it will nonetheless have broad application in all areas of wireless content download mechanisms.

ICC System and Overview

The content delivery system and method of the current invention may be configured using currently existing WAP and Internet server technologies with a new file downloading mechanism called Internal Code Control (ICC) which makes use of the Multipurpose Internet Mail Extension (MIME) type format and file segmentation techniques to facilitate file transfer and download verification. According to the current invention, downloading functions of the ICC mechanism may be accomplished via an Index Parsing (INP) method. The present invention thus provides a low cost, expandable media content download mechanism which enables users of portable devices to download media content from a standard Internet server using a WAP browser.

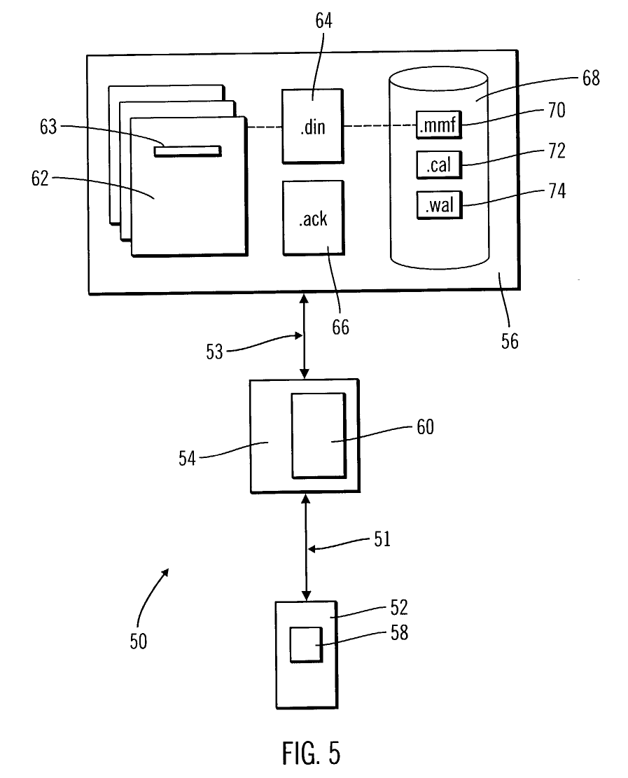

The content delivery system 50 of the current invention is shown schematically in FIG. 5, and generally comprises a portable device 52, gateway 54, and Internet server 56. According to one aspect of the present invention, the system hardware elements (portable device 52, gateway 54, and Internet server 56) are standard elements commonly used in WAP enabled systems enabled with ICC functionality. The portable device 52 (which according to one embodiment of the present invention is a standard cellular phone) is shown with installed WAP browser 58. Portable device 52 contains functional control system elements such as a central processing unit (CPU), memory, and a display. WAP browser 58 may be any browser capable of implementing MIME type files, and displaying Wireless Markup Language (WML) or other markup language pages. WAP browser 58 may also include elements such as a parser for processing incoming files and instructing browser interactions with the Internet server 56 and file concatenation mechanism for reassembling file components which are received from Internet server 56. Gateway 54 is a WAP enabled gateway for translating HTTP to optimized web code (generally WML) in the encoder and decoder 60. Gateway 54 with included encoder and decoder 60 is a standard WAP gateway according to the current invention. Information may be transmitted wirelessly (illustrated at 51) between portable device 52 and gateway 54 by a number of known wireless communication technologies including, but not limited to cellular technologies, GSM, GPRS, CDMA, WiFi, Bluetooth, etc. Internet server 56 is a standard computer system implemented with such server technology as Microsoft™ Internet Information Server (IIS), Apache Server, or similar software elements according to the current invention, and does not contain additional costly proprietary software or hardware elements to manage the downloading of media content files such as wallpapers, ringtones, and caller ID information. The server generally contains control system elements such as a CPU, one or more hard drives or other storage media, and memory. Standard web page 62 is shown which contains the HTML, ASP, WML or other known Internet coding language elements to define graphical, textual, and hyperlink information 63 to be displayed in WAP browser 58 of portable device 52. According to the current invention, link information 63 on web page 62 corresponds to a particular download index file 64, which in turn corresponds to a particular media content file (ie. ringtone 70 which is stored in object database 68) to be downloaded to portable device 52. Object database 68 is shown containing media content files of types 70 (ringtone files), 72 (caller ID files), and 74 (wallpaper files), however it will be understood and appreciated by those skilled in the art that files of all different types may be stored in object database 68 for download to portable device 52. Internet server 56 also contains acknowledgement file 66 for verification to portable device 52 that all segments of media content file 70 were downloaded successfully. Internet server 56 and gateway 54 are connected (shown at 53) via known methods such as cabling, or alternatively may be functional components of the same Internet hosting device. Not shown in content delivery system 50 of FIG. 5 is an optional billing or payment mechanism, such that payment for downloaded media content 70 may be accomplished. The billing mechanism may be integrated with Internet server 56 or may be a separate module which is connected with Internet server 56 via known methods. Any existing billing or payment technology may be integrated with the ICC mechanism by those skilled in the art such that billing functions of the current system are accomplished. Internet server 56 may be a secure web server according to one embodiment of the present invention. Well-known security mechanisms such as SSL may be implemented with the current invention to allow encrypted data transfer between the Internet server 56 and portable device 52.

MIME Types:

According to the present invention, multiple MIME types are defined for content download including both known, and newly defined MIME types. For purposes of illustration and description, three known MIME types are provided in the current invention however it will be appreciated by those skilled in the art that many types, including currently known types and newly developed types may be implemented in the present invention. The *.wal (where * is any filename) format is a characterized as a wallpaper MIME type and consists of graphic content to create so called “wallpaper” backgrounds on portable devices. The *.cal (where * is any filename) format is characterized as a Caller ID MIME type and consists of graphic content corresponding to an incoming callers name. The *.mmf (where * is any filename) format is characterized as a ringtone MIME type and consists of data which is playable by the audio playback unit of a portable device. The generation and implementation of MIME types is well known in the art.

The present invention also presents two new MIME types (a download index type and acknowledgment type) which are used to accomplish downloading and transfer verification of media content files, and are not themselves media content types. Each new MIME type file consists of a series of machine-readable instructions according to the MIME specification to govern the content download and verification process. By providing the Download index and Acknowledgment files as MIME types on both the portable device and Internet server, files using the appropriate Download index and Acknowledgment file extensions become readable using a standard WAP web browser and do not require the use of additional software or hardware elements on the Internet server.

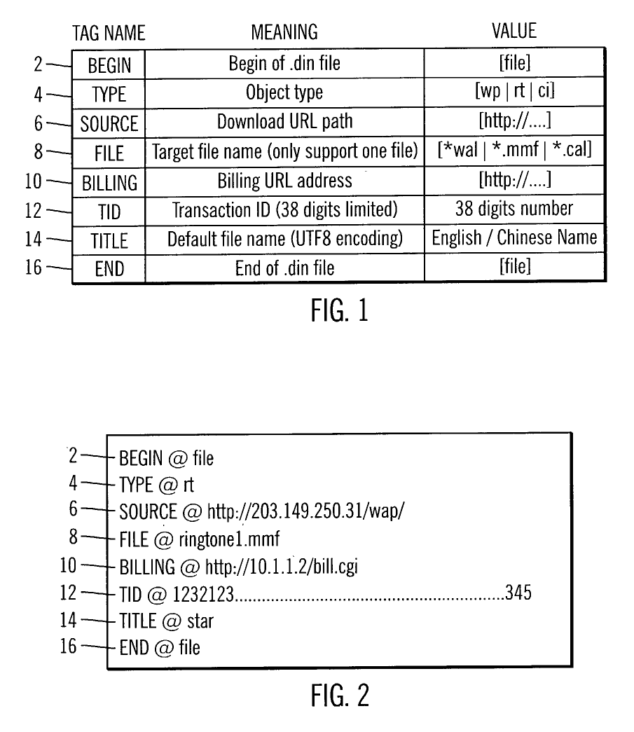

A Download index MIME type file is defined and provided to indicate instructions to the browser of the portable device to complete the download procedure of a particular media content file. FIG. 1 shows the tag definitions of the Download index file, and FIG. 2 illustrates a sample *.din file according to the current invention. The BEGIN tag 2 indicates the beginning of the *.din file to the browser and uses the syntax “BEGIN @ file”. TYPE tag 4 indicates the object type to the browser and uses the syntax “TYPE @ xx” where “xx” is an object value. According to the current invention, wallpaper objects are indicated by the value “wp”, ringtone objects by the value “rt”, and caller ID objects by the value “ci”. Other object values may be used by providing values corresponding to object types residing on the Internet sever which may be downloaded by the browser. The SOURCE tag 6 indicates the download Uniform Resource Locator (URL) path, which according to the current invention corresponds to the location where a particular media file to be downloaded resides on the Internet server. SOURCE tag 6 uses syntax “SOURCE @ http://location” where location is the download path. The FILE tag 8 indicates the actual name of the file to be downloaded, and uses the syntax “FILE @ name.ext” where name is the file name and ext is the file extension (ie. wal, .mmf, or .cal). The BILLING tag 10 indicates the URL for performing the billing functions of the current download, and uses the syntax BILLING @ http://billinglocation” where billinglocation is the billing server path. The billing function is optional according to the current invention. The TID tag 12 indicates the Transaction ID for the particular content download event to the portable device, and uses the syntax “TID @ #” where # is the Transaction ID number corresponding to the download event. The TID is used for download verification functions, and may consist of any number of digits or characters according to the particular requirements of a media file download system. The TID may be generated dynamically by software components on the server such that Download Index and acknowledgement files associated with a particular media file have matching TID numbers, which differ from all other TID's for different media files. The TITLE tag 14 indicates the default file name (in standard UTF8 encoding format) of the object being downloaded, and uses the syntax “TITLE @ name” where name is the default file name. The END tag 16 indicates the end of the .din file has been reached so the browser may cease parsing of the file and more on to the next step. The syntax for the END tag is “END @ file”.

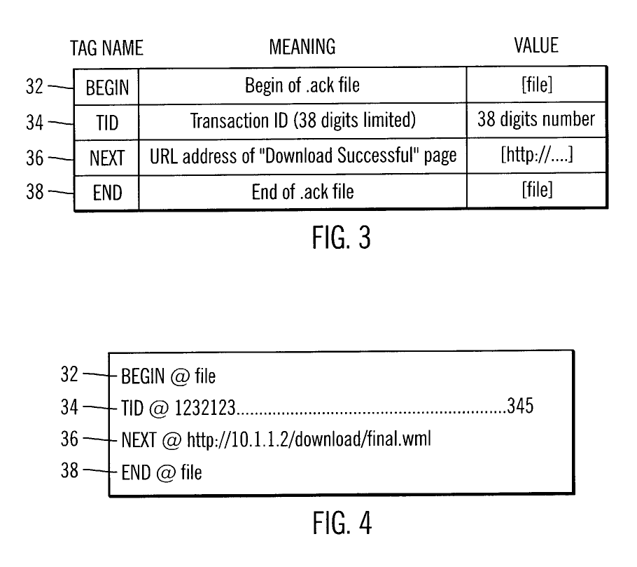

An Acknowledgment MIME type file is defined and provided to indicate instructions to the browser of the portable device to verify the success of content download using the TID and to load the downloaded media content file into portable device memory for use on the portable device. FIG. 3 shows the tag definitions of the Acknowledgement file, and FIG. 4 illustrates a sample .ack file according to the current invention. The BEGIN tag 32 indicates the beginning of the .ack file to the browser and uses the syntax “BEGIN @ file”. TID tag 34 indicates the Transaction ID for the particular content download event to the portable device, and uses the syntax “TID @ #” where # is the Transaction ID number corresponding to the download event. In the case of the .ack file, the TID tag 34 is used to match against previously sent TID tag 12 from the .din file for content verification purposes. The NEXT tag 36 indicates to the browser the URL for confirming a successful download of the content file, and uses the syntax “NEXT @ http://successlocation” where successlocation is the “Download Successful” page server path. The END tag 38 indicates the end of the .din file has been reached so the browser may cease parsing of the file and more on to the next step. The syntax for the END tag is “END @ file”.

Both Download Index and Acknowledgement files may be generated dynamically according to one aspect of the present invention. For instance, it is well within the routine skill of a software engineer to develop CGI, ASP, or other code to dynamically generate both .din and .ack files for particular media content files to be made available for download from a server. It will be understood and appreciated by those skilled in the art that many code formats and syntax protocols may be used in defining download index and acknowledgement files without departing from the spirit and scope of the current invention.

ICC INP Method:

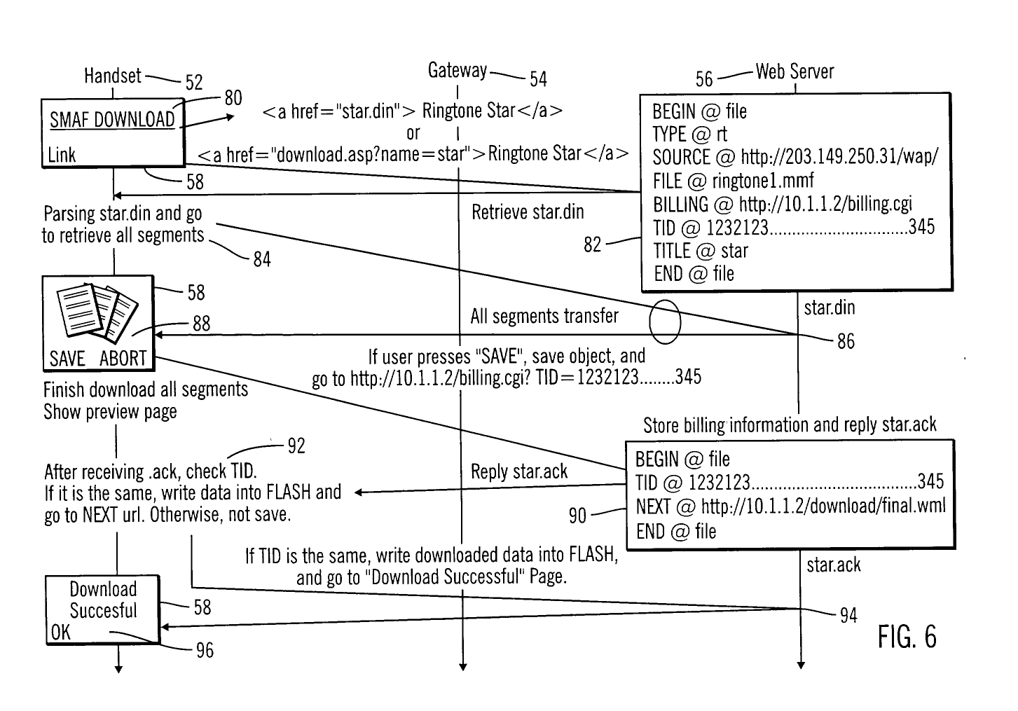

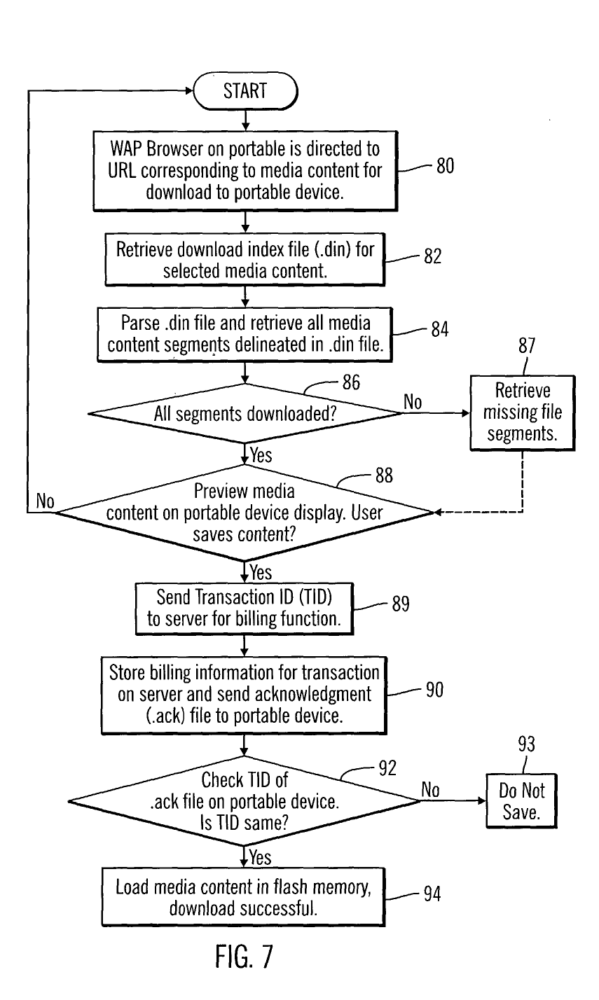

An Index Parsing (INP) method of the invention is provided as follows. In general, the INP method of the current invention implements the new Download index and Acknowledgement MIME types in a download process to facilitate the transfer of media content files from a server to a portable device via standard WAP browser based communications. In order to accomplish media file transfer using the INP method, both new MIME types (.din and .ack) must be configured in the internet MIME type settings on both server and portable devices such that they are associated with the browser as executable code. Looking now to FIGS. 6 and 7, the ICC Index Parsing method is shown both in process flow and schematic formats. FIG. 6 shows the flow of the INP process between the portable device 52, gateway 54, and Internet server 56. In the first step 80, a hyperlink to a Download index file corresponding to media content on the Internet server is displayed in the browser of portable device 52. In the illustrated example, a ringtone Download index file “star.din” is displayed as a hyperlink in browser 58. In step 82, a user has clicked on the Download index hyperlink initiating the Internet server 82 to send the “star.din” file to the browser. In step 84 the star.din Download index file is parsed by the browser. In general, the parser is a software implemented function integrated with the browser which is capable of parsing both .din and .ack files which are downloaded by the browser. It is well within the routine skill of a software engineer to develop a simple parser using “C” or other programming language to accomplish the necessary parsing tasks of the browser. Step 86 shows the transfer of segments of the media file (star.din in the example) to the browser. According to the present invention, media files may be segmented using one of two approaches, “Pre-Segment” (PS) or “Dynamic-Segment” (DS), both described in detail below. In step 87 (shown in FIG. 7) missing file segments are downloaded from the Internet server if some were not initially retrieved successfully. The determination of any unsuccessfully downloaded file segments, and subsequent re-downloading operations, may be performed by the ICC parser in reference to the file segment information contained in din files. In step 88, all segments of the media file have been transferred to the browser and the file has been appropriately concatenated to be identical to the original file on the Internet server. A preview page is displayed in browser 58 wherein the user may audition the downloaded content before purchase of saving of the file to memory of the portable device. If the user decides to abort saving of the media file, the process is stopped and the user may direct the browser to a new media content file and start the INP method again. If the user decides to purchase and save the media file, the TID from the star.din file is sent to the billing server in step 89 (shown in FIG. 7) so that billing functions may be performed before loading of the media file onto the portable device. Once billing information for the download has been stored, the Internet server replies to the browser with the Acknowledgement file (star.ack in the current example) in step 90. In step 92, the browser receives the star.ack file and parses the file to check the TID from star.ack against the TID from star.din in order to verify the transaction. If the TIDs from Download index and Acknowledgment files are not the same, the downloaded media file is not saved to portable device memory and the downloading procedure is stopped in step 93 (shown in FIG. 7). If TID from star.ack is the same as TID in star.din, then the media file is saved to portable device flash memory for use on the portable device, and download successful page is sent by the Internet server in step 94. In step 96 the “Download Successful” page is displayed in the browser 58 confirming to the user that the media file was successfully transferred to and implemented on the portable device for use.

In another embodiment of the current invention, a second method is provided for naming file segments and delineating file types on the web server for easy download by the portable device. Media files are segmented according to the predefined specification and named such that the file type and number of segments for a particular download will be discernable by the browser.

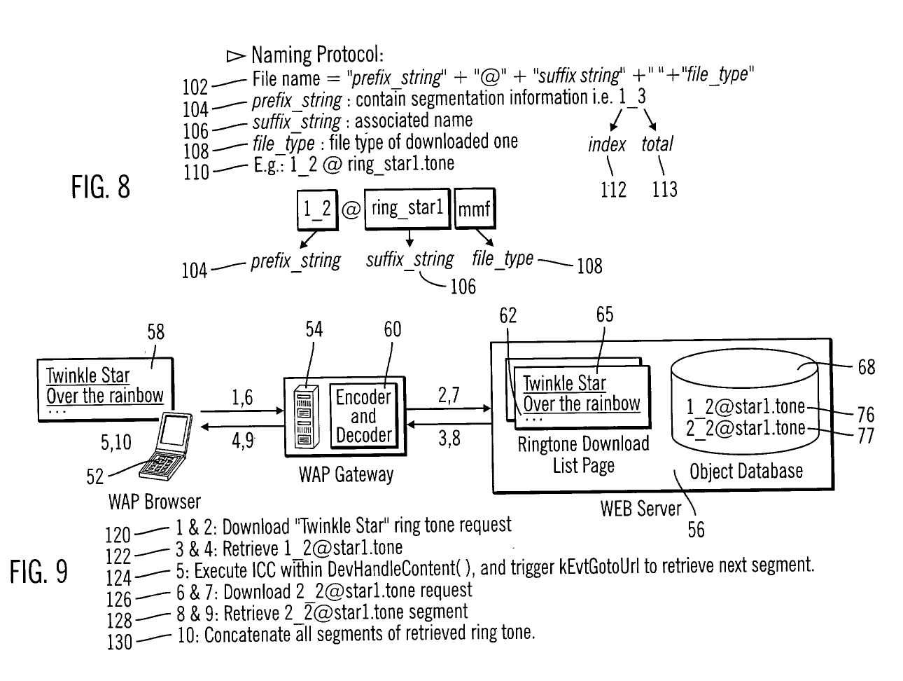

This second embodiment of the current invention serves to provide a common file-naming scheme to be used in the ICC download mechanism. A text schematic of the method of the second embodiment is shown in FIG. 8. Because files over a certain size (generally 2810 bytes) may not be downloaded in whole via WAP applications, files of these larger sizes must be segmented prior to or during the download procedure and then concatenated on the portable device save in memory. In order for the browser of the portable device to download and implement content from the Internet server, such a file naming protocol must be used for large file (ie. those over the 2810 byte limit).

In general, the second embodiment includes using three naming fields: a prefix string (prefix_string) 104, a suffix string (suffix_string) 106, and a file type (file_type) 108. The prefix string 104 contains the segmentation information for a particular file to be downloaded. An index 112 and total 113 placeholder are used to identify the order of a particular file segment relative to the total number of segments existing for a particular media file. Suffix string 106 is the name of the associated file. The file type 108 indicates file type of the downloaded file. For instance, sample file ring_star1 shown in FIG. 8 contains two segments. The first segment 76 would be named “1_{—}2@ring_star1.tone” while the second segment 77 would be named “2_{—}2@ring_star1.tone” according to the current invention.

Looking now to FIG. 9, the method of downloading each file segment from the Internet server to the browser of the portable device is shown schematically. In step 120 a download request for a particular media file is made to Internet server 56 via hyperlink 65 displayed in browser 58. In the current example, the media file is a ringtone “Twinkle Star” comprising two segments, “1_{—}2@star1.tone” 76 and “2_{—}2@star1.tone” 77 stored in the object database 68 of Internet server 56. Hyperlink 65 corresponds to the first file segment 76 according to the current invention. In step 122 the first file segment “1_{—}2@star1.tone” 76 is sent from Internet server 56 to browser 58. In step 124 the first file segment 76 is handled by the ICC Parser and a trigger is invoked to retrieve the next file segment from the server. In step 126, the Internet server 56 has been triggered to transfer the second file segment (“2_{—}2@star1.tone” 77 in the current example) to browser 58. The second file segment 77 is received by the browser 58 in step 128. Both segments are then concatenated in step 130 such that the full ringtone file is formed and available to the user for implementation. In general the file for particular media content will be divided on the server based on the PS or DS segmentation approach (outlined below) prior to download via the method of the second embodiment. Each segment is named according to the naming protocol specified in FIG. 8 and related description. In this way it is possible using the present method of the second embodiment to download files of any length.

File Segmentation:

As described above, Object files for download on the server may be segmented using either Pre-Segment or Dynamic-Segment techniques to separate the object into smaller portions for download to the portable device. FIG. 11 generally shows the Internet Server process flow for object file segmentation using PS and DS methods. Using the PS approach, all Objects over a pre-defined size are segmented on the server prior to the initiation of a download procedure. The preset file segment size may be calculated using the following method according to one embodiment of the current invention:

Segment Size(S)=Standard Internet Protocol (IP) Packet size−Wireless Service Provider (WSP) header size−User Datagram Protocol (UDP) header size−IP header size.

The resultant Segment Size “S” may be applied to object files for download, each object being segmented into portions equal to or less than the value S. Using this approach, din files may be pre-generated for each download object, the segmented file names being entered in the “FILE” field of the din file. In one embodiment of the present invention, the calculated segment size was discovered to be 2810 bytes, however it would be possible to use segment sizes of different values given modifications in the various protocol and header size requirements.

The Dynamic-Segment approach allows object segmentation to be performed dynamically, by the web server, upon initiation of an object download. It is based on the Internet Server's ability to receive the Protocol Data Unit (PDU) size of the portable device initiating a download request via WSP header information. When an Internet Server receives a din request, it will use the WSP header information (as defined in the WAP specification) in order to calculate object segmentation size “D” according to the following relationship:

D=PDU size of portable device−WSP header size−UDP header size−IP header size

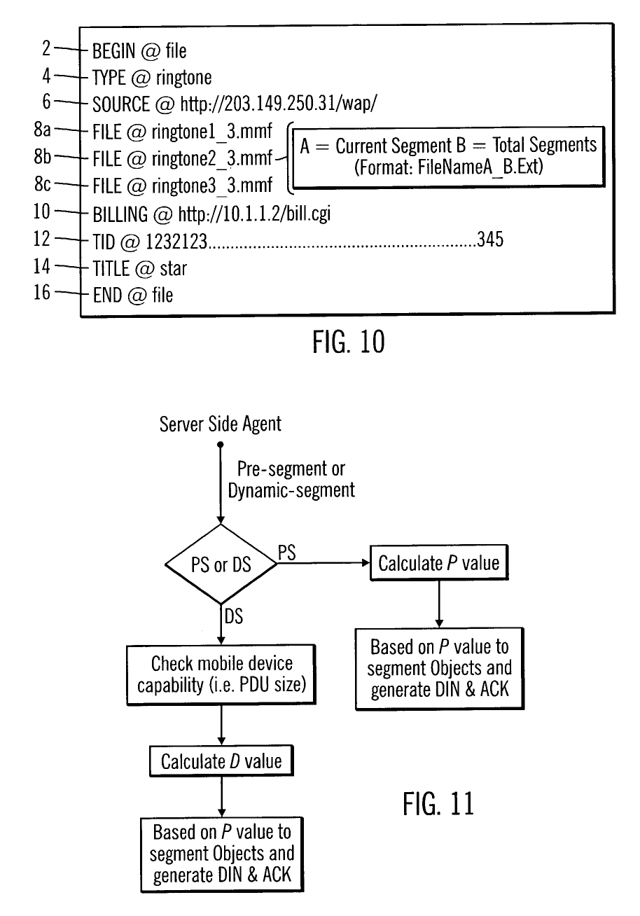

The .din file may then be dynamically generated using the value “D,” and all segmented file names sequentially entered in the “FILE” field of the .din file as shown in FIG. 10. The .din file shown in FIG. 10 contains three “FILE” fields (8a, 8b, and 8c) as opposed to the single “FILE” field 8 shown in FIG. 2. Each field 8a, 8b, and 8c defines a file segment name using the format “FileNameA_B.ext” where “FileName” is the name of the object file to be downloaded, “B” is the total number of segments in which the object file was divided, “A” indicates the order of a particular segment in relation to the total number of segments, and “ext” is the object extension. It should be appreciated by those skilled in the art that many variations to the file name format used for defining file segments in the “FILE” field of the din file are possible without departing from the scope and spirit of the current invention.

The system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each system element is not necessary for an enabling understanding of the invention. The actual implementation is well within the routine skill of a programmer and system engineer, given the disclosure herein of the system attributes, functionality and interrelationship of the various functional modules and elements in the system. A person skilled in the art, applying ordinary skill can practice the present invention without undue experimentation.

The system is configured such that users may download and purchase media content on a portable device using a simple WAP browser and ordinary Internet sever and gateway. The system is also expandable to download other file types and to work with different download protocols and specifications. The billing functions and security mechanisms described in connection with the current invention are option features and enhancements which may be used in conjunction with the current invention. In general the particular nomenclatures and naming protocols used in describing the present invention should be considered illustrative of the underling conceptual elements (namely providing for the download of media files using the Index parsing method), and not taken in a limiting sense. It will be understood and appreciated by those skilled in the art that many variations to the particular names and types assigned the various MIME types and methods of the current invention are possible without departing from the spirit and scope of the current invention.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A system for downloading an object file, said system comprising:
a server configured to recognize a first file format and a second file format;
a portable device in communication with the server via a wireless communication link;
a browser included on the portable device, said browser configured to recognize files in said first file format and said second file format;
a first file residing on the server configured in said first format which facilitates the downloading of the object file to the portable device via the browser; and
a second file residing on the server configured in said second format which facilitates confirmation of downloading of the object file to the portable device via the browser.

2. A system as in claim 1, wherein said first file format and said second file format comprises Multipurpose Internet Mail Extension (MIME) types.

3. A system as in claim 2, wherein said first file and said second file further comprise first and second file extensions respectively, for indicating the file format to the browser.

4. A system as in claim 1, wherein said server comprises an object file segmentation means for dividing an object file included on the server into a series of object file segments.

5. A system as in claim 4, wherein each said object file segment in said series is given a name by said object file segmentation means, wherein a first portion of said name indicates the total number of related object file segments in the series, and a second portion of said name indicates the order of the particular object file segment in said series.

6. A system as in claim 4, wherein said object file segmentation means comprises a pre-segmentation means for dividing object files according to a predetermined byte size.

7. A system as in claim 4, wherein said object file segmentation means comprises a dynamic-segmentation means for dividing object files according to a dynamically determined byte size.

8. A system as in claim 1, wherein said server comprises an Internet server having user-configurable MIME type settings.

9. A system as in claim 1, wherein said first file comprises:
an object file type indicator;
a source location path;
a target file name; and
an identification number.

10. A system as in claim 9, wherein said target file name consists of a reference to one of either an object file or an object file segment.

11. A system as in claim 9, wherein said first file further comprises a billing location path for providing payment functions for the system.

12. A system as in claim 1, wherein said portable device comprises:
user configurable MIME type settings;
a parsing means for processing said first file and said second file received via said browser; and
a file concatenation means for generating the object file from the series of downloaded object file segments.

13. A system as in claim 12, wherein the portable device includes said first file format and said second file format configured in said user-configurable MIME type settings.

14. A system as in claim 1, wherein said object file comprises a media object file.

15. A system as in claim 14, wherein said media object file is at least one of a ringtone file, a wallpaper file, or a caller ID file.

16. A server configured to download an object file to a portable device, said server comprising:
a first file configured according to a first MIME type specification which is used by said portable device to facilitate downloading of said object file to said portable device;
a second file configured according to a second MIME type specification which is used by said portable device, to confirm the successful downloading of the object file to the portable device; and
a control system for controlling the functions of the server and sending files to said portable device.

17. A portable device configured to download an object file from a server, said portable device comprising:
a browser configured to recognize files from the server in a first MIME format and a second MIME format, said browser interacting with said server to download a first file in said first MIME format and a second file in said second MIME format;
a parser for processing files in said first and second MIME formats to instruct said browser to interact with said server such that said object file is downloaded to said portable device; and
a control system for controlling the functions of said browser and said parser to download an object file from the server.

18. A method of downloading an object file residing on a server to a portable device via a browser on the portable device, said method comprising the steps of:
providing a first file format and a second file format on both the server and the portable device;
providing a first file configured in said first file format on the server, said file referencing at least a portion of the object file;
providing a second file configured in said second file format on the server;
downloading said first file to said portable device via the browser;
downloading said object file to said portable device using said first file;
sending said second file to said portable device via the browser;
confirming the download of said object file to said browser using said second file; and
enabling said object file on said portable device.

19. A method as in claim 18, further comprising an object segmentation step before providing said first file.

20. A method as in claim 18, further comprising a billing step before said sending step for enabling billing for said object file.
